(19) United States
(12) Patent Application Publication
(10) Pub. No.: US 2007/0226642 A1
(43) Pub. Date: Sep. 27, 2007

(54) Apparatus and method for displaying transparent windows when copying or moving items between windows

(75) Inventor: Christophe Nasarre Soulier, Rieux (FR)

Correspondence Address: COOLEY GODWARD KRONISH LLP;ATTN: Patent Group, Suite 500, 1200 - 19th Street, NW, Washington, DC, 20036-2402, US

(73) Assignee: Business Objects, S.A., Levallois-Perret (FR)

(21) Appl. No.: 11/387,939

(22) Filed: Mar. 22, 2006

(51) Int. Cl. G06F 3/048

(52) U.S. Cl. 715/768; 715/769; 715/803

(57) ABSTRACT

A computer readable medium includes executable instructions to identify that a first graphical user interface window is displayed in front of a second graphical user interface window. Executable instructions identify when a user is copying or moving an item from the first graphical user interface window. The transparency of the first graphical user interface window is then altered.

### BRIEF DESCRIPTION OF THE INVENTION

This invention relates generally to apparatus and methods for displaying and manipulating graphical information. More particularly, this invention relates to applying transparency to a graphical user interface window when copying or moving items from one graphical user interface window to a second graphical user interface window.

### BACKGROUND OF THE INVENTION

Graphical User Interface (GUI) interactions with a product often include multiple “windows” on a display device in order to enable the user to work with different documents within a product, or different sets of functionality within a product. Contemporary GUI based operating systems, such as Microsoft Windows™, often enable a user to have multiple windows including windows of more than one application available at any given time. These multiple windows provide the user with the ability to toggle between windows and applications.

Often, because of limited display device 104 screen real estate, shown in Prior Art FIG. 1, it is difficult for the user to see the contents of a second window when a first window is displayed in front of the second window. This interferes with common tasks such as copying or moving items from a first window to a second window. In particular, when the first window 102 from which the user is copying an item is displayed on top of the second window 100 in which the user wants to place the item, it is difficult for the user to place the item in a specific location within the second window 100 without multiple operations.

The multiple operations associated with the prior art are illustrated in FIG. 2. A graphical user interface (GUI) window is displayed 200. GUI window B is displayed or moved in a way that obscures at least a portion of GUI window A 202. A user selects an item in GUI window B and drags the item 204. The user places the item in a portion of window A that is visible 206. The user selects window A such that it is displayed on top of window B 208. The user then adjusts the position of the copied item in window A 210.

Alternatively, a more advanced user, who is familiar with shortcuts in an operating system or software applications, can select the item from the first window, use a keyboard shortcut (such as “Ctrl+C”) to copy the item, a second shortcut (such as “Alt+Tab”) to shift activation and focus to the second window, such that it displays in front of the first window, and a third shortcut (such as “Ctrl+V”) to paste the item in the second window. Both of these prior art workflows do not enable the user to select and copy the item from the first window into every position within the second obscured window without shifting the activation and focus to the second window through either a keyboard shortcut or a mouse selection.

A software program is often designed to be used in combination with other software programs that are programmed, produced, and manufactured by different companies. Although the user interacts with the two software programs, copying data and other items between the two software programs is constrained in terms of how the software programs can interact and control each other. Each software program typically controls how its own GUI windows are displayed. This adds a degree of complexity when a first software application attempts to negotiate the display of GUI windows that belong to other software applications.

In view of the foregoing, it would be desirable to provide improved techniques for copying or moving items between windows. In particular, it would be desirable to provide techniques for displaying a first window with a degree of transparency when that first window obscures a second window underneath it, especially when copying or moving an item from that first window into the second window.

### SUMMARY OF THE INVENTION

The invention includes a computer readable medium with executable instructions to identify that a first graphical user interface window is displayed in front of a second graphical user interface window. Executable instructions identify when a user is copying or moving an item from the first graphical user interface window. The transparency of the first graphical user interface window is then altered.

Parent and child terminology is typically used to describe the relationship between a window (the parent) that is used as a container for other windows (the child), in which they render themselves, and are constrained (or clipped) by the dimensions of the parent window. In one embodiment of the invention, the child windows of the parent window are hidden when transparency is applied to ensure they cannot receive the mouse messages required by the windows below the parent window during a standard drag and drop workflow.

### BRIEF DESCRIPTION OF THE FIGURES

The invention is more fully appreciated in connection with the following detailed description taken in conjunction with the accompanying drawings, in which:

FIG. 1 illustrates a prior art graphical user interface for dragging and dropping items between windows.

FIG. 2 illustrates a prior art workflow for dragging and dropping items between windows.

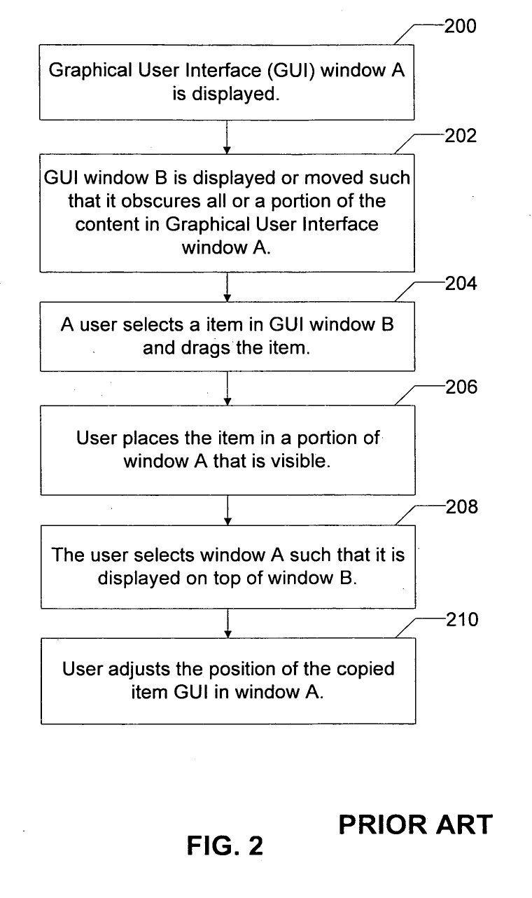

FIG. 3 illustrates a computer configured in accordance with an embodiment of the invention.

FIG. 4 illustrates copying and transparency operations performed in accordance with an embodiment of the invention.

FIG. 5 illustrates the interaction between GUI windows in accordance with an embodiment of the invention.

FIG. 6 illustrates a workflow for applying transparency in accordance with an embodiment of the invention.

FIG. 7 illustrates a workflow for actions after the drag and drop operation is completed or canceled in accordance with one embodiment of the invention.

FIG. 8 illustrates a screenshot configured in accordance with an embodiment of the invention.

FIG. 9 illustrates variation in the workflow based on whether the parent window contains a child window.

FIG. 10 illustrates child windows within a parent window.

Like reference numerals refer to corresponding parts throughout the several views of the drawings.

### DETAILED DESCRIPTION OF THE INVENTION

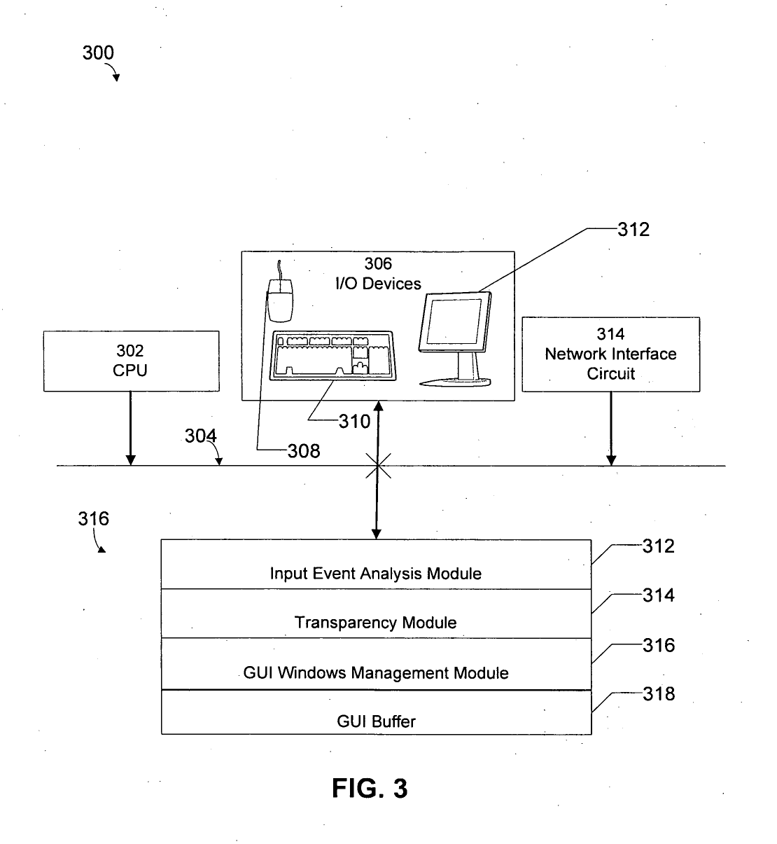

FIG. 3 illustrates a computer 300 configured in accordance with an embodiment of the invention. The computer 300 has standard components including a central processing unit 302, a bus 304, input/output devices 306, and an optional network interface circuit 314. The input/output devices 306 include input devices such as a keyboard 310, mouse 308, and a display, such as monitor 312. In addition input/output devices 306 may include input/output devices such as handwriting recognition tablets, touch screen displays, scanners, printers, and the like. The optional network interface circuit 314 facilitates communications with networked computers (not shown). The computer 300 also includes a memory 316. The memory 316 includes executable instructions to implement operations of the invention.

In the example of FIG. 3, the memory 316 includes an Input Event Analysis Module 312, a Transparency Module 314, a GUI Windows Management Module 316, and a GUI buffer 318. The Input Event Analysis Module 312 analyzes user activity including determining whether a user is copying or moving items from one window to another window. The GUI buffer 318 is used to store the currently displayed GUI window images in memory. The Transparency Module 314 includes instructions to render a GUI window with a degree of transparency. The configuration of FIG. 3 is simplified for illustrative purposes.

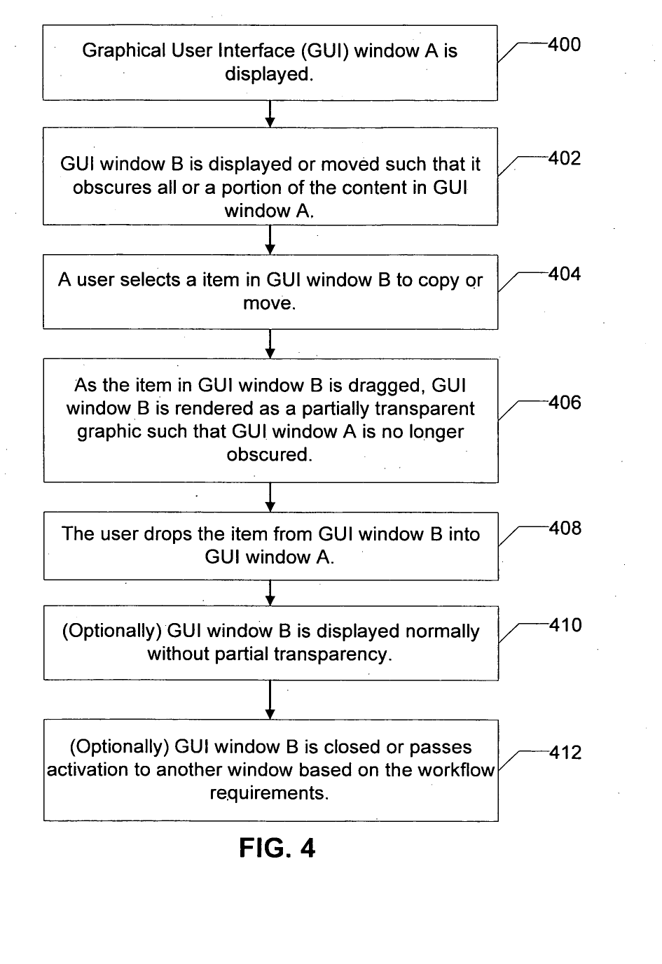

FIG. 4 illustrates the workflow for an embodiment of the invention. A first GUI window A is displayed 400. Then a second GUI window B is displayed, or moved, such that it obscures a portion of the first GUI window A 402. A user selects an item from window B to copy or move 404. Selecting an item to copy or move includes clicking and dragging using a mouse or other pointing device, using touching and dragging on a touch screen monitor, or another method recognized by the operating system.

The type of item being copied or moved from GUI window B includes a complete file or folder, or a portion or item from a report or other document displayed in GUI window B. For example text, a piece or series of data, or a chart or multiple charts, or a combination of items can be copied from a report or other document in GUI window B, to a report or other document in GUI window A. Other documents include a Microsoft Excel™ spreadsheet or a Microsoft Word™ document.

As the user either drags the item, or moves the mouse pointer to the second window, GUI window B is rendered as partially transparent such that GUI window A is no longer obscured 406. In this way the layout, including cells, and existing content in GUI window A can clearly be seen by the user to enable the user to place the item from GUI window B in the precise location desired in GUI window A and not merely in the portion of window A where window B does not overlap. In one embodiment of the invention, the degree of transparency applied to window B is configurable by the end user.

The user then drops the item from window B into window A 408. At this point, the copying or moving is complete. Optionally, Window B is then restored to its normal display state, without partial transparency, that was displayed prior to the copying or moving operation 410. Depending on the implementation, and the workflow being supported, when the copying or moving workflow is complete the behavior of Window B may include closing, losing activation (passing it to another window) or maintaining a transparent display 412. FIG. 4 describes a simplified interaction with two GUI windows for the purpose of illustration. The invention applies to interactions between a plurality of GUI windows.

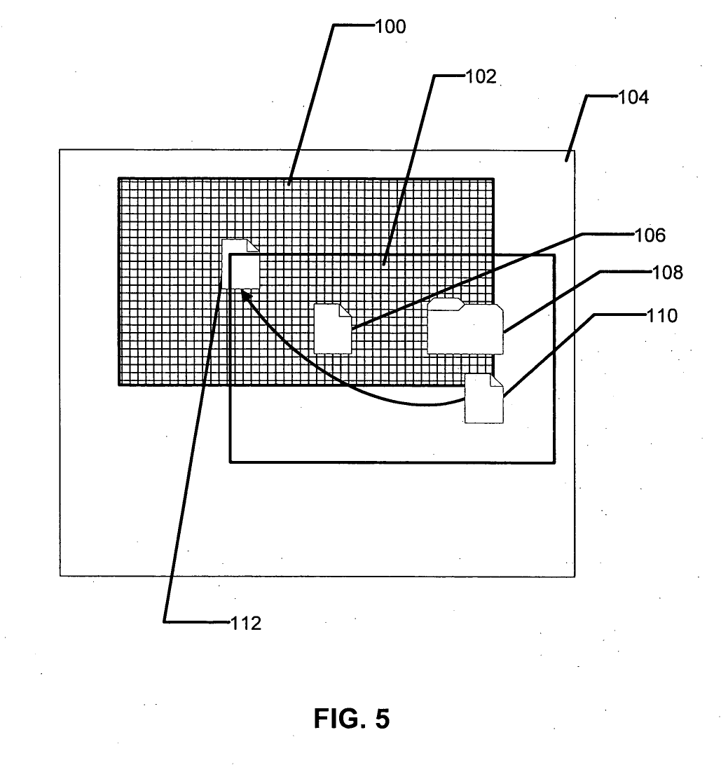

FIG. 5 illustrates the interaction between window A and window B during a copying or moving operation. A display device 104 displays two GUI windows, window A 100 and window B 102. The display device 104 may be a monitor, a touch screen, or another device used to display information to the user. In FIG. 5 there are there are three items in window B 106, 108, 110. In this example, a user selects item 110 to move or copy from window B 102 to window A 100. As the user selects item 110, window B 102 becomes partially transparent such that the content of window A 100 in this case a cell grid, is visible even in the sections of window A 100 that window B 102 covers and that were obscured before partial transparency was applied to window B 102.

FIG. 5 shows the transparency being applied to window B 102 as item 110 is moved or copied to window A 100. Optionally, this transparency is removed after item 110 is placed in window A 100. Although in this figure item 110 is shown as being copied to window A 100 in an area, that is only partially covered by window B 102, this is merely for the purposes of illustration, and item 110 could be copied anywhere within window A 100 without limitation due to the presence of window B.

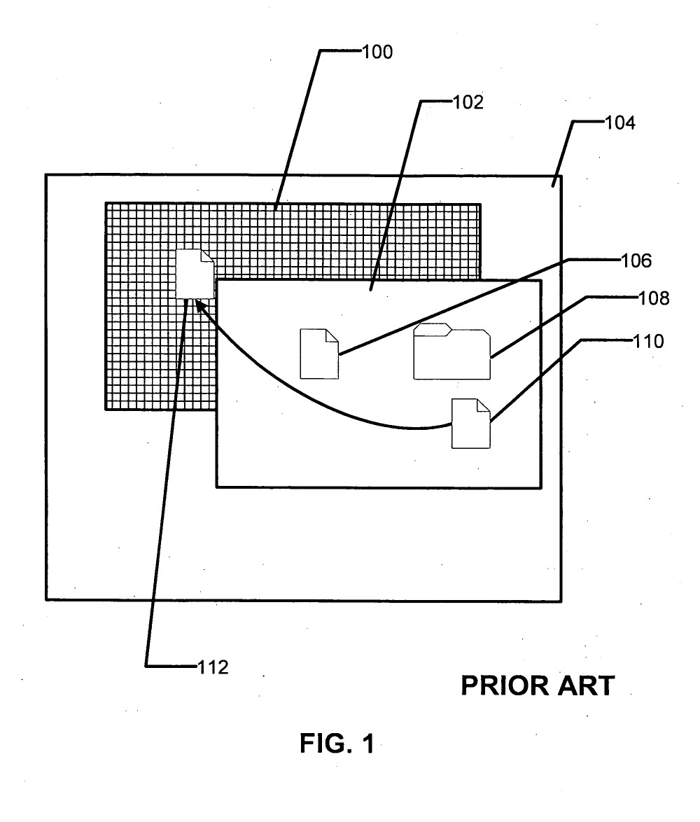

FIG. 5 distinguishes the invention from the prior art shown in FIG. 1. In the prior art shown in FIG. 1, no degree of transparency is applied to window B to assist the user in accurate placement of the item during a copy or move operation. In the prior art, when GUI window B obscures another GUI window A, while window B is displayed in front, the copy can only be placed in a portion of window A that is not obscured by window B. In the prior art, to display window A in front of window B would require switching the window activation by clicking window A or using a shortcut such as ALT-TAB.

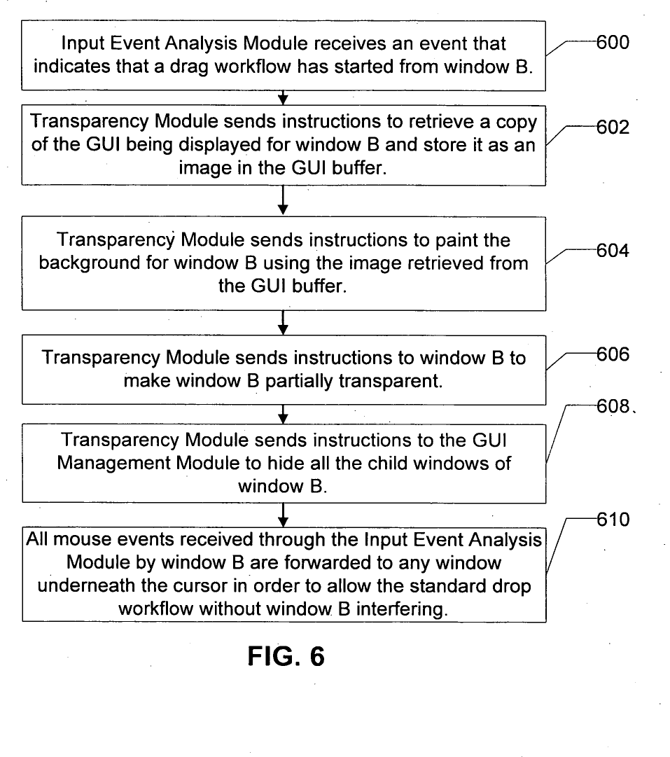

FIG. 6 illustrates the workflow for an embodiment of the invention. The Input Event Analysis Module 312 receives an event that indicates that the user has selected an item from a window B for moving or copying where window B obscures window A 600. In one embodiment of the invention, process 600 occurs without detecting whether Window B obscures another window. The Transparency Module 314 sends instructions to retrieve a copy of the GUI being displayed for window B 602 and store it in the GUI Buffer 318. This copy of the GUI being displayed is retrieved as an image. In one implementation, the image copy of the GUI being displayed that is retrieved includes child windows for window B. This optional operation is used to improve the consistency of the user's experience when the child windows of window B 608 are hidden.

The Transparency Module 314 sends instructions to use the GUI image copied from the GUI buffer 318 as a painting background for Window B 604 and Window B is displayed as a partially transparent window 606. This GUI component copied from the GUI buffer also includes the child windows of window B. By setting the GUI buffer as a painting background for the existing GUI window, the general appearance of window B stays the same despite the hiding the child windows. This previously opaque window B is now transparent but leaves the original window layout visible as a painting background and is displayed as a partially transparent window 606. The user is unaware that the content of the original window B has been replaced with an image and the child windows have been hidden, and replaced with an image of the previous window state; from the user's perspective it simply appears that window B has had a degree of transparency set to it.

The Transparency Module 314 sends instructions to the GUI Management Module 316 to hide all the child windows of window B 608. If not concealed, these child windows could intercept the mouse messages that need to be passed through to other windows during the drag and drop operation.

All mouse events received through the Input Event Analysis Module 312 by window B are forwarded to any window underneath the cursor in order to allow the standard drop workflow without window B interfering 610.

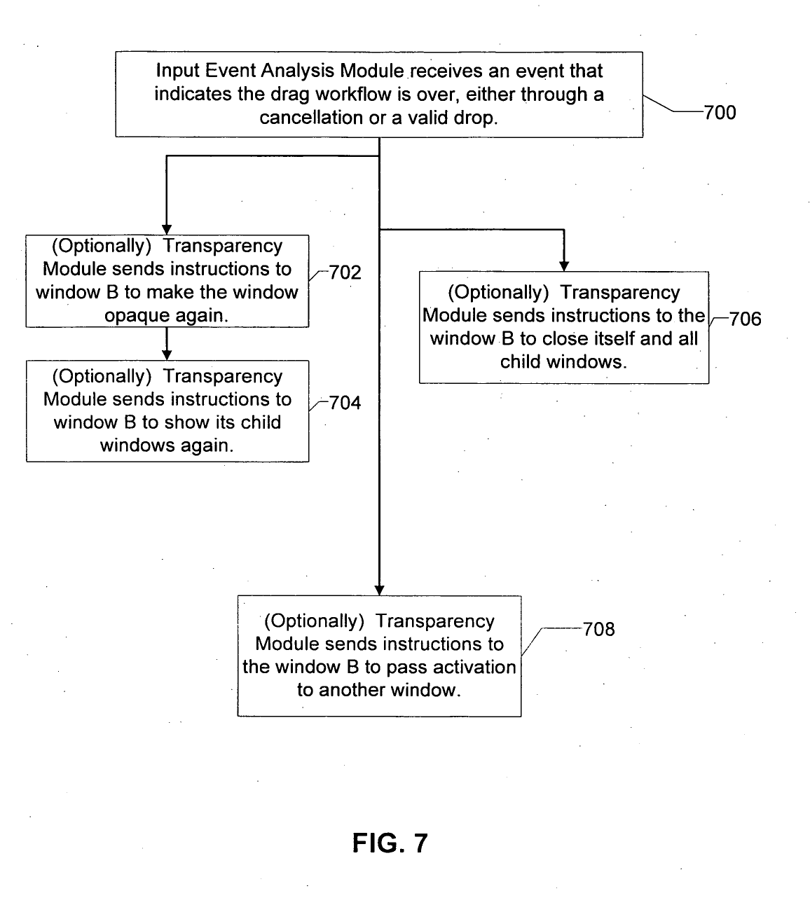

FIG. 7 continues the workflow illustrated in FIG. 6. The Input Event Analysis Module 312 receives an event that indicates the drag workflow is over, either through a cancellation or a valid drop 700. Depending on the implementation, the Transparency Module 316 optionally sends instructions to window B to make the window opaque again 702, to show its child windows again 704, instructions to window B to close itself and its child windows 706, or instructions to pass activation to another window 708, or combinations of these instructions.

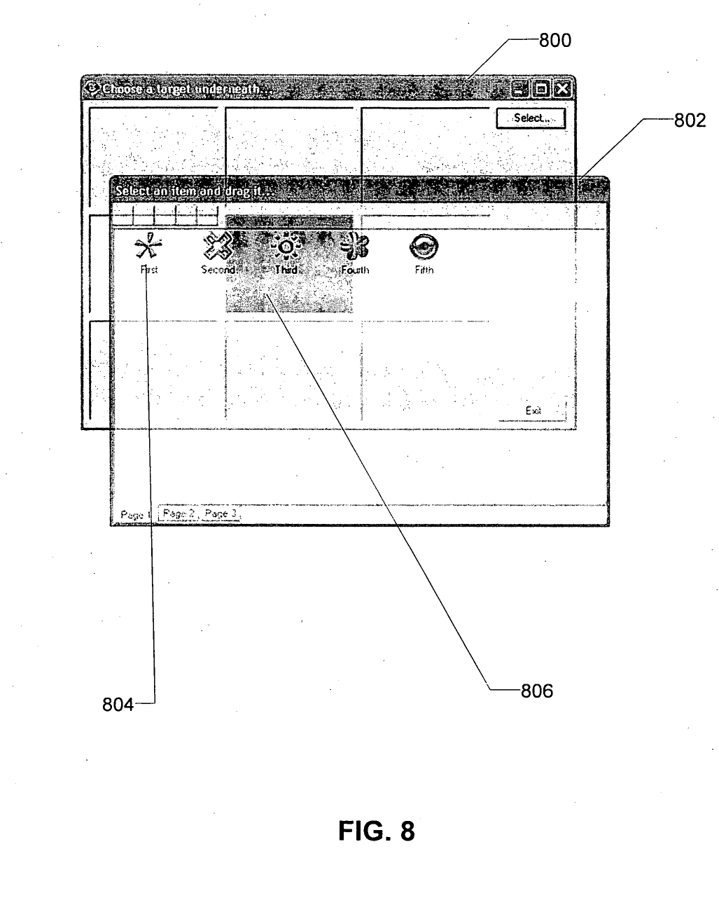

FIG. 8 provides a screenshot of one embodiment of the invention. Window A 800 is partially obscured by a partially transparent Window B 802 as an item 804 is dragged and dropped to a specific grid location 806 on Window A. Until the drag and drop operation was initiated, Window A 800 was obscured by Window B 802 in the same manner as the FIG. 1 representation of the prior art. After, the drag operation is initiated, Window B is displayed as partially transparent as illustrated in FIG. 5. FIG. 8 illustrates the invention user interface for a drag and drop operation to place an object accurately within a portion of a Window A that would typically be obscured by Window B.

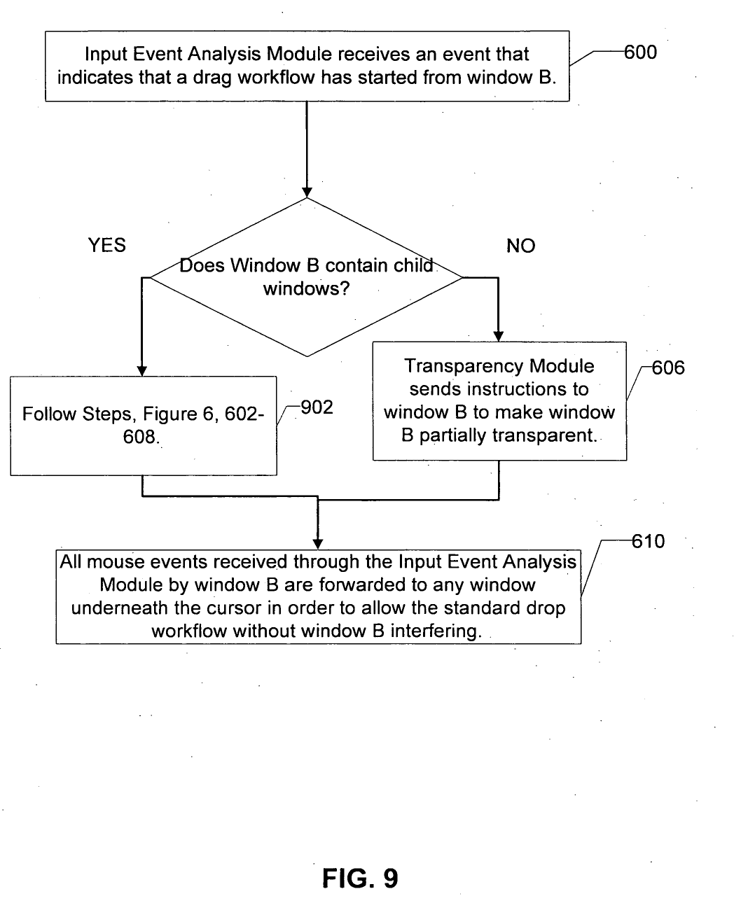

FIG. 9 illustrates variation in the workflow based on whether window B contains child windows. The input event analysis module receives an event that indicates that a drag workflow has started in window B 600. In the case where the window B does contain child windows, the process follows the workflow illustrated in FIG. 6 (block 902 of FIG. 9) and in the case where window B does not contain child windows, there is a simplified workflow that directly renders the window as transparent 606. In both cases, mouse events received by window B are passed to any window underneath the cursor to enable the drag and drop operation without interference from window B 610.

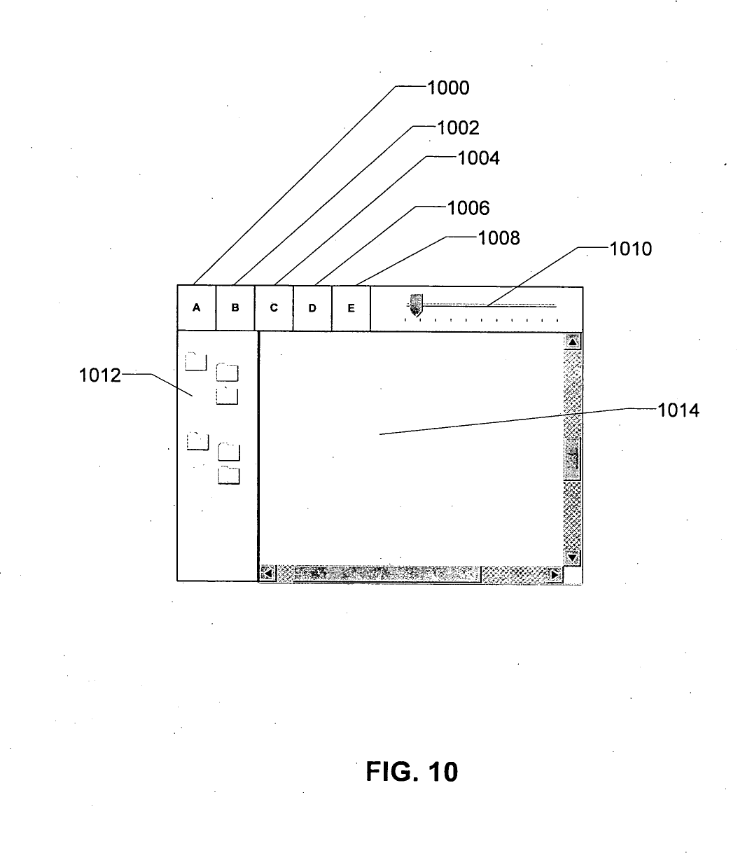

FIG. 10 illustrates the use of child windows within a typical windows environment. The use of child windows within a parent window is an implementation choice in many GUI environments. Using child windows may reduce the amount of code required to represent a given GUI and may increase efficiency by having an operating system handle a larger portion of the window rendering and refreshing operations to support the GUI rather than requiring code to redraw the entire window area. FIG. 10 illustrates areas in a typical GUI that might be represented by individual child windows. These include buttons 1000-1008, a tree control 1012, a slider control 1010, and a main text entry area 1014.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C#, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium comprising executable instructions to:
identify that a first graphical user interface window is displayed in front of a second graphical user interface window;
identify that a user is copying or moving an item from the first graphical user interface window; and
alter the transparency of the first graphical user interface window.

2. The computer-readable medium of claim 1 further comprising executable instructions to:
identify that a user has completed copying or moving an item from the first graphical user interface window; and
restore the first graphical user interface window to an original state.

3. The computer-readable medium of claim 1 wherein the executable instructions to alter the transparency of the first graphical user interface window further comprise executable instructions to configure the degree of transparency.

4. The computer-readable medium of claim 1 wherein the executable instructions to alter the transparency of the first graphical user interface window further comprise executable instructions to retrieve a copy of the first graphical user interface window as an image, set the copy as a painting background in the first graphical user interface window, set the first graphical user interface window partially transparent, and forward all mouse events received by the first graphical user interface window to the second graphical user interface window.

5. The computer-readable medium of claim 1 wherein the executable instructions to alter the transparency of the first graphical user interface window further comprise executable instructions to hide a child window of the first graphical user interface window.

6. The computer-readable medium of claim 5 further comprising executable instructions to:
identify that a user has completed copying or moving an item from the first graphical user interface window; and
restore the child window of the first graphical user interface window.

7. A computer readable medium comprising executable instructions to:
identify that a drag and drop operation has been initiated from a first graphical user interface window; and
alter the transparency of the first graphical user interface window.

8. The computer-readable medium of claim 7 wherein the executable instructions to alter the transparency of the first graphical user interface window further comprise executable instructions to retrieve a copy of the first graphical user interface window as an image, set the copy as painting background in the first graphical user interface window, set the first graphical user interface window partially transparent, and forward all mouse events received by the first graphical user interface window to the second graphical user interface window.

9. The computer-readable medium of claim 7 further comprising executable instructions to restore the first graphical user interface window to an original state after the drag and drop operation is completed.

10. The computer-readable medium of claim 7 further comprising executable instructions to display a child window after the drag and drop operation is completed.

11. The computer-readable medium of claim 7 further comprising executable instructions to close the first graphical user interface window after the drag and drop operation is completed.

12. The computer-readable medium of claim 7 further comprising executable instructions to direct cursor events received at the first graphical user interface window to a window underneath the first graphical user interface window.

13. The computer-readable medium of claim 7 further comprising executable instructions to configure the degree of transparency.
